(19) United States
(12) Patent Application Publication
(10) Pub. No.: US 2026/0283872 A1
(43) Pub. Date: Sep. 24, 2026

(54) WHEELCHAIR

(71) Applicants: The United States Government as represented by the Department of Veterans Affairs, Washington, DC (US); Regents of the University of Minnesota, Minneapolis, MN (US)

(72) Inventors: Kimberly Gastafson, Minneapolis, MN (US); William K. Durfee, Minneapolis, MN (US); Gregory Owen Voss, Apple Valley, MN (US); Andrew Hansen, Apple Valley, MN (US); Gary D. Goldish, Plymouth, MN (US)

(21) Appl. No.: 19/474,849

(22) PCT Filed: Apr. 12, 2024
(86) PCT No.: PCT/US2024/024325

§ 371 Date: Oct. 13, 2025

Related U.S. Application Data
(60) Provisional application No. 63/496,067, filed on Apr. 14, 2023.

(51) Int. Cl. A61G 5/04; A61G 5/12; G01L 1/22

(52) U.S. Cl. CPC A61G 5/048; A61G 5/045; A61G 5/128; G01L 1/22

(57) ABSTRACT

A wheelchair having a frame, a footplate that is coupled to the frame and movable relative to the frame about and between a lowered position and a raised position, and a lever that permits actuation of the footplate about and between the lowered position and the raised position. Also disclosed is a wheelchair having a pair of drive wheels, at least one motor, wherein each motor of the at least one motor coupled to a respective drive wheel of the pair of drive wheels, at least one sensor. A controller is in communication with the at least one sensor and each motor of the at least one motor. The controller is configured to control operation of the motor based on input from the at least one sensor.

### CROSS-REFERENCE TO RELATED APPLICATION

This application claims priority to and the benefit of the filing date of U.S. Provisional Patent Application No. 63/496,067, filed Apr. 14, 2023, the entirety of which is incorporated by reference herein.

### FIELD

This disclosure relates to wheelchairs and, in particular, to wheelchairs having features for assisting a caregiver.

### BACKGROUND

As the population ages, the number of caregivers in the United States is growing rapidly. The burden on these caregivers is exacerbated by steadily increasing obesity rates, which are highest in adults aged 50 to 70. Difficulties of caregiving using wheelchairs include positioning the individual in a wheelchair as well as propelling the wheelchair with the individual therein.

### SUMMARY

Disclosed herein, in one aspect, is a wheelchair comprising a frame and a footplate that is coupled to the frame and movable relative to the frame about and between a lowered position and a raised position. A lever permits actuation of the footplate about and between the lowered position and the raised position. The lever is pivotable about a first pivotal axis in a first pivotal direction from a first position in which the footplate is in the lowered position and a second position in which the footplate is in the raised position. A first shaft is coupled to the lever so that pivotal movement of the lever about the first pivotal axis effects pivotal movement of the first shaft about the first axis. A second shaft is pivotably coupled to the frame about a second axis. The second shaft is coupled to the footplate so that pivotal movement of the second shaft effects movement of the footplate about and between the lowered position and the raised position. A linkage couples the first shaft to the second shaft so that application of a downward force against the footplate when the footplate is in the raised position effects a torque applied to the first shaft in the first pivotal direction.

Also disclosed herein is a wheelchair comprising a frame and a pair of drive wheels rotatably coupled to the frame. The wheelchair comprises at least one motor. Each motor of the at least one motor is coupled to at least one drive wheel of the pair of drive wheels. At least one handle is coupled to the frame. The at least one handle is configured for pushing by a caregiver positioned behind the wheelchair. At least one sensor is configured to measure a force applied to the at least one handle. A controller is in communication with the at least one sensor and each motor of the at least one motor. The controller is configured to receive at least one input from the at least one sensor corresponding to the force applied to the at least one handle. The controller is configured to control operation of the at least one motor based on at least one input from the at least one sensor.

Also disclosed herein is a wheelchair comprising a frame. A first structure is pivotably coupled to the frame about a first axis. The first structure comprises a handle. A second structure that is pivotably coupled to the frame about a second axis. The second structure comprises a footplate. A bar pivotably coupled to the first structure about a third axis and pivotably coupled to the second structure about a fourth axis. Pivotal movement of the handle about the first axis effects pivotal movement of the footplate about the second axis.

Additional advantages of the disclosed apparatuses, systems, and methods will be set forth in part in the description that follows, and in part will be obvious from the description, or may be learned by practice of the claimed invention. The advantages of the disclosed devices and systems will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a front perspective view of an exemplary wheelchair in accordance with embodiments disclosed herein.

FIG. 2 is a rear perspective view of the exemplary wheelchair of FIG. 1.

FIG. 3 is a side view of the exemplary wheelchair of FIG. 1, the wheelchair having a footplate in a lowered position.

FIG. 4 is a side view of the exemplary wheelchair of FIG. 1, in which the footplate is in a raised position.

FIG. 5 is a front perspective view of the exemplary wheelchair of FIG. 1, in which the wheelchair is in a folded configuration.

FIG. 6 is a side view of the exemplary wheelchair of FIG. 1, in which the wheelchair is in a folded configuration.

FIG. 7 is a schematic view of certain elements of the exemplary wheelchair of FIG. 1 associated with the footplate, showing an arrangement in which the footplate is in the lowered position.

FIG. 8 is a schematic view of the certain elements of the exemplary wheelchair associated with the footplate as in FIG. 7, showing an arrangement in which the footplate is in the raised position.

FIG. 9 is a schematic view of certain elements of the exemplary wheelchair of FIG. 1 associated with the footplate, showing an arrangement in which the footplate is in the lowered position.

FIG. 10 is a schematic view of the certain elements of the exemplary wheelchair associated with the footplate as in FIG. 9, showing an arrangement in which the footplate is in a toggle position between the lowered position and the raised position.

FIG. 11 is a schematic view of the certain elements of the exemplary wheelchair associated with the footplate as in FIG. 9, showing an arrangement in which the footplate is in the raised position.

FIG. 12 is a block diagram of aspects of elements of the disclosed wheelchair associated with propulsion.

Various embodiments are described in detail below with reference to the accompanying drawings, wherein like reference numerals represent like elements.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can include plural referents unless the context clearly dictates otherwise. For example, unless the context dictates otherwise, use of the term “a lever” can represent disclosure of embodiments in which a single such lever is provided, as well as disclosure of embodiments in which a plurality of such levers are provided.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

As the population ages, the number of caregivers in the United States is growing rapidly. The burden on these caregivers is exacerbated by steadily increasing obesity rates, which are highest in adults aged 50 to 70. The disclosed wheelchair can address the difficulty many caregivers experience assisting in the transportation of moderate to low mobility care recipients outside of the home for appointments, community engagements, or fresh air excursions. It is not uncommon for the caregiver to be elderly or of a smaller build than the care recipient, increasing the difficulty of pushing a transport chair for extended distances or across uneven or unlevel terrain. The disclosed wheelchair can be equipped with intelligent motorized wheels that engage in the forward or reverse directions to maintain a consistently low effort required from the caregiver, independent of the weight of the care recipient. The wheelchair can assist on uphill terrain and slow on downhill descents to match the walking speed of the caregiver. In addition, the chair can have a drop-down footplate that eliminates the need for the legs of the care recipient to be lifted onto foot pedals once seated. This footplate can also serve as a brake to eliminate safety concerns associated with the chair rolling back as the user transitions between sitting and standing. Although the disclosed wheelchair can comprise motorized elements, unlike a conventional motorized wheelchair, the disclosed wheelchair is lightweight, foldable, and easy to maneuver in and out of a vehicle.

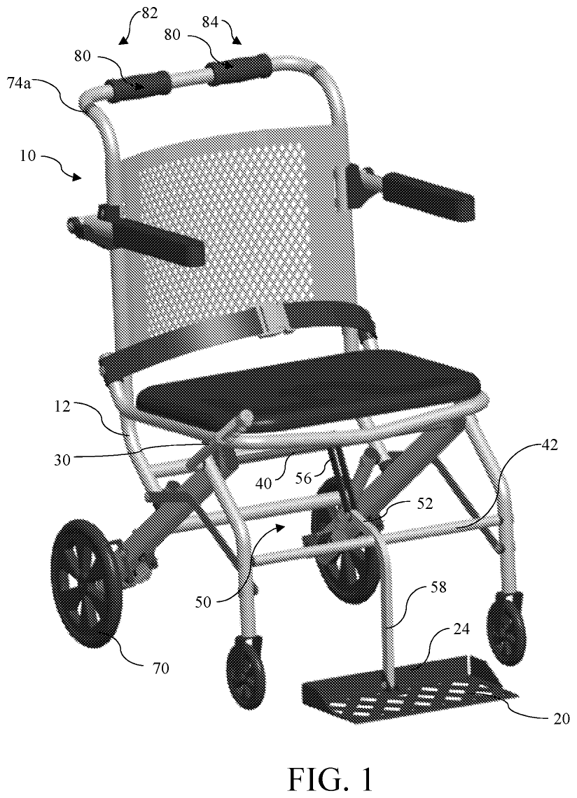

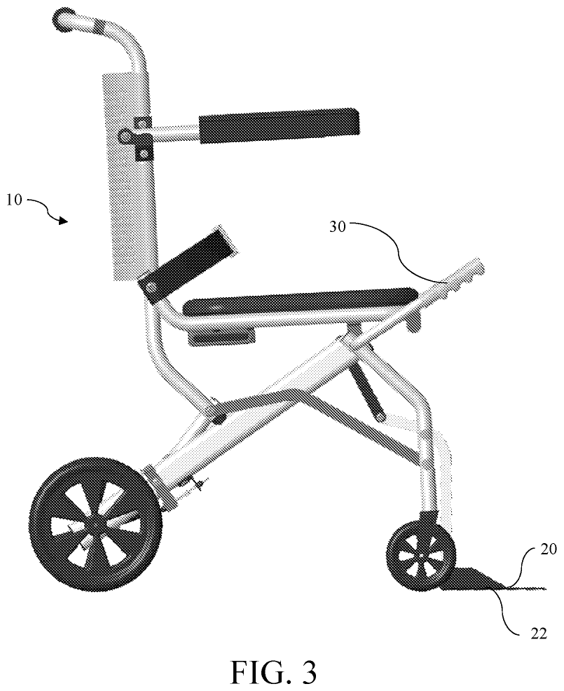

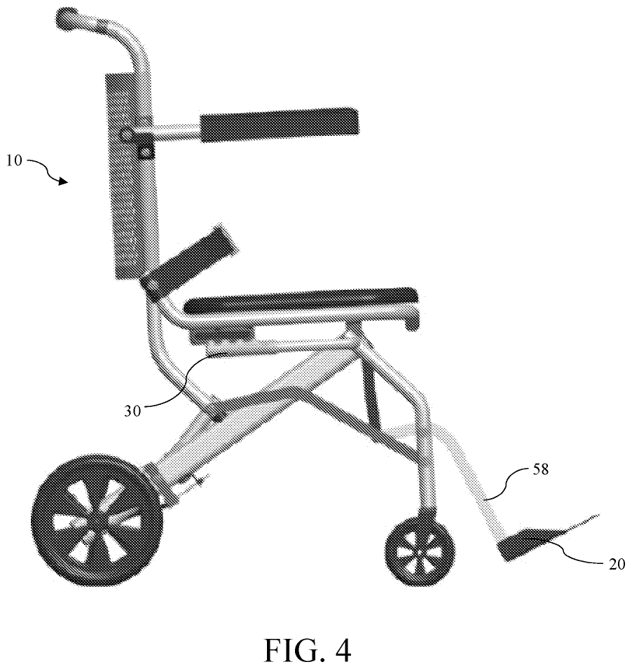

Disclosed herein, and with reference to FIGS. 1-8, is a wheelchair 10 having a frame 12. The wheelchair 10 can further comprise a footplate 20 that is movable relative to the frame about and between a lowered position (FIG. 3) and a raised position (FIG. 4). For example, in the lowered position, the footplate 20 can rest against and contact the ground. Optionally, in these aspects, the footplate 20 can be flush with the ground. In other aspects, in the lowered position, the footplate 20 can be within about 3 inches of the ground, within about 2 inches of the ground, or within 1 inch of the ground. In some aspects, when the footplate is in the lowered position, the footplate can be parallel to or generally parallel to the ground (e.g., within 15 degrees, within 10 degrees, within 5 degrees, or within 1 degree of parallel to the ground). The wheelchair 10 can comprise a lever 30 that permits actuation of the footplate 20 about and between the lowered position and the raised position.

Referring to FIGS. 1, 7, and 8, the lever 30 can be pivotable about a first pivotal axis 32 in a first pivotal direction 33 from a first position (FIG. 3) in which the footplate is in the lowered position and a second position (FIG. 4) in which the footplate is in the raised position. A first shaft 40 can be coupled to the lever 30 so that pivotal movement of the lever about the first pivotal axis 32 effects pivotal movement of the first shaft about the first axis. A second shaft 42 can be pivotably coupled to the frame 12 about a second axis 34. The second shaft 42 can further be coupled to the footplate 20 so that pivotal movement of the second shaft 42 effects movement of the footplate 20 about and between the lowered position and the raised position.

As shown in FIG. 1, a linkage 50 can couple the first shaft 40 to the second shaft 42 so that application of a downward force against the footplate 20 when the footplate is in the raised position (FIG. 4) effects a torque applied to the first shaft 40 in the first pivotal direction. In this way, weight of the user against the footplate 20 does not cause the footplate to lower to the lowered position. Instead, the weight of the footplate 20 and the weight of the user can retain the footplate in the raised position, thereby preventing jostling or rough terrain from causing the footplate to lower. Instead, the footplate 20 can be lowerable only by actuation of the lever 30.

In some aspects, the linkage 50 can comprise a first arm 52 fixedly coupled to extending radially from the first shaft 40 so that rotation of the first shaft effects rotation of the first arm 52. The linkage 50 can further comprise a second arm 54 fixedly coupled to extending radially from the second shaft 42 so that rotation of the second arm 54 effects rotation of the second shaft 42. A bar 56 can couple to the first arm 52 at a third pivotal axis 36. The bar 56 can couple to the second arm 54 at a fourth pivotal axis 38.

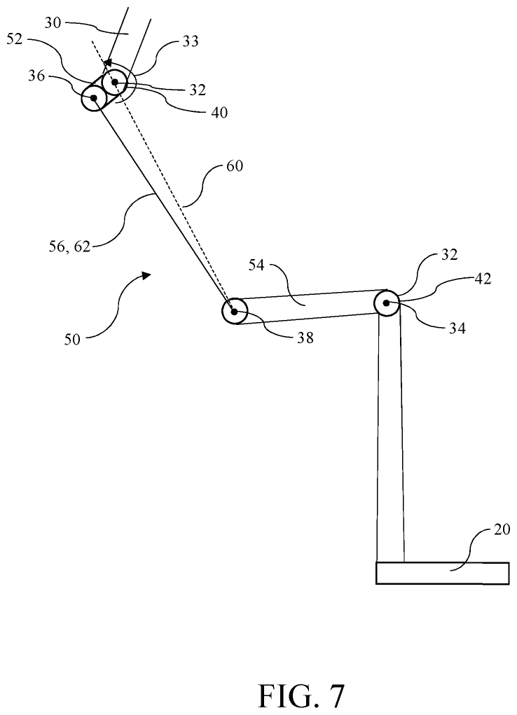

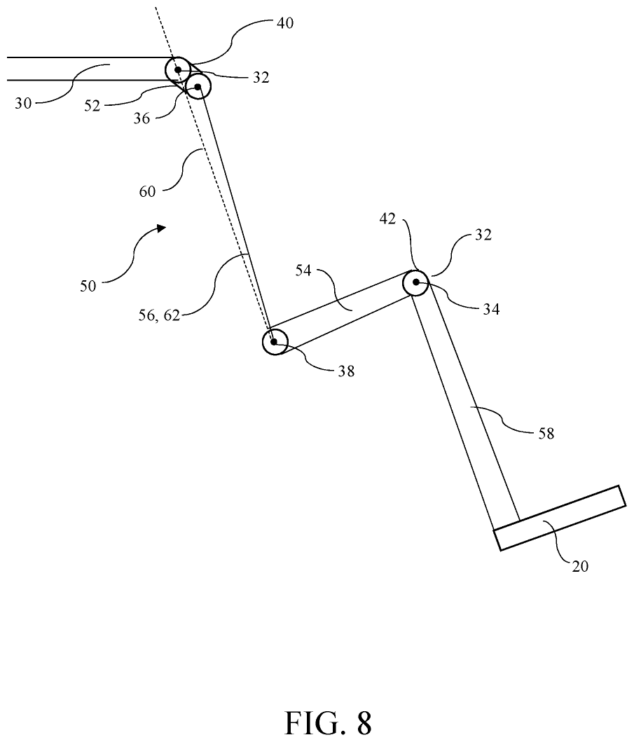

A first plane 60 includes the first and fourth axes 32, 38. A second plane 62 includes the third and fourth axes 36, 38. At the crossing of the third axis 36 over the first plane 60 (e.g., as the first and second planes 60, 62 are coplanar), torque of the second shaft about the second axis can transition a direction of torque applied to the first shaft. When the footplate 20 is in the lowered position (FIG. 7), the third axis 36 can be on a first side of the first plane 60, and when the footplate is in the raised position (FIG. 8), the third axis 36 can be on a second side of the first plane 60, opposite the first side of the first plane 60.

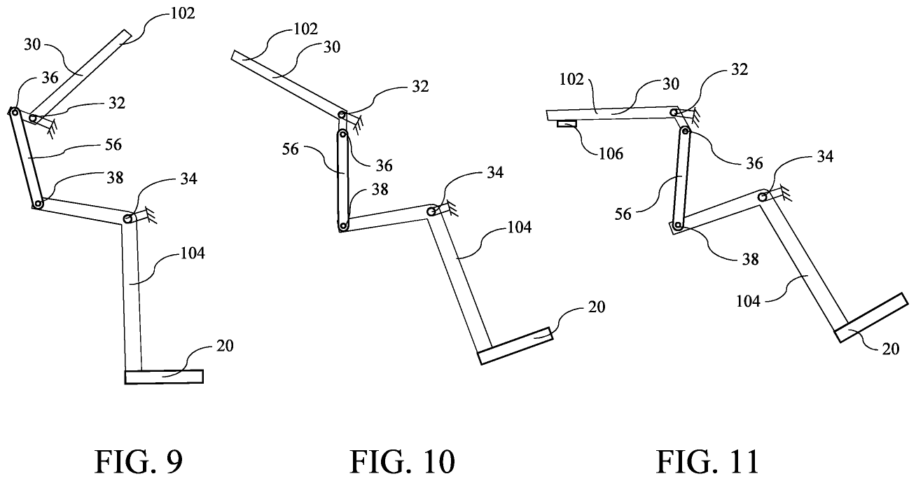

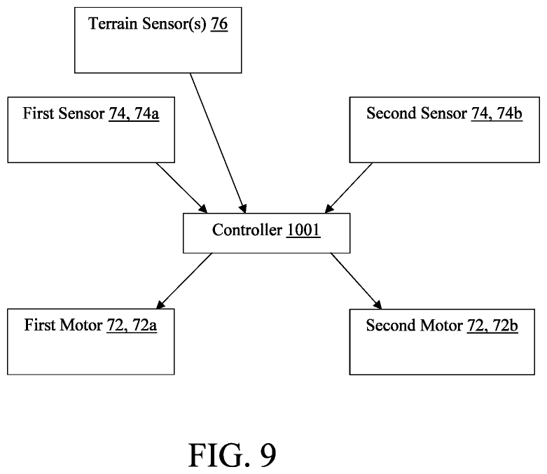

Referring also to FIGS. 9-11, the wheelchair 10 can comprise a first structure 102 that is pivotable about the first axis 32 and a second structure that is pivotable about the second axis 34. The first and second axes 32, 34 can be fixed relative to the frame 12. The first structure 102 can comprise the lever 30 and the first arm 52 (FIG. 8). For example, the lever 30 can couple to the first arm 52 via the first shaft 40 (FIG. 8). The second structure 104 can comprise the footplate 20 and the second arm 54 (FIG. 8). The bar 56 can couple the first structure 102 to the second structure 104. In the configuration in FIG. 9, downward force applied to the footplate 20 can effect clockwise torque of the second structure 104 that, in turn, applies a clockwise torque to the first structure 102 via the bar 56. In the configuration in FIG. 11, downward force applied to the footplate 20 can effect clockwise torque of the second structure 104 that, in turn, applies a counterclockwise torque to the first structure 102 via the bar 56. In some aspects, the first structure 102 (e.g., the lever 30) can engage a stop surface 106 to inhibit further clockwise movement of the first structure, thereby inhibiting further movement of the footplate 20. FIG. 10 illustrates a toggle point at which the torque applied to the first structure 102 by the second structure due to a counterclockwise torque on the second structure 104 changes direction.

In some aspects, the footplate 20 can be fixedly coupled to the second shaft 42 so that pivotal movement of the second shaft effects corresponding pivotal movement of the footplate. Accordingly, in these aspects, the footplate can be configured for pivotal movement about and between the lowered position and the raised position. In other aspects, the second shaft can indirectly couple to the footplate (e.g., via a 4-bar linkage). Optionally, in these aspects, the footplate can be configured to move about and between the lowered position and the raised position along any suitable pathway.

The lever 30 can provide a mechanical advantage so that rotation of the lever 30 by a first angle pivots the at least one pivot arm by a second angle that is less than the first angle. For example, in some aspects, the lever 30 can be pivotable at least 90 degrees, or at least 120 degrees, or more than 130 degrees as in order to move the footplate 20 about and between the lowered position and the raised position. In some aspects, the footplate 20 can pivot about and between the lowered position and the raised position from about 10 degrees to about 45 degrees, or from about 15 degrees to about 30 degrees.

In various aspects, the footplate 20 can be configured to receive both feet of the user. Optionally, in these aspects, the footplate 20 can be a unitary footplate. The footplate 20 can couple to the linkage 50 via an arm 58. In some aspects, the arm 58 can couple to the footplate 20 at a central position along a transverse axis (e.g., between the feet of the user). In some aspects, a non-slip coating 22 can be provided on the bottom side of the footplate 20. For example, the non-slip coating can comprise a tacky surface such as rubber or tacky polymer/elastomer (e.g., silicone or synthetic rubber). In other aspects, the non-slip coating can comprise a rough surface. In this way, the footplate 20 can serve as a brake to prevent rollback or movement of the wheelchair 10 as the rider sits. In some aspects, the lever can be located to be accessible to both the user and the caregiver. For example, the lever can be positioned at seat height (e.g., on one side of the wheelchair).

Accordingly, the footplate 20 eliminates the need for the user or the caregiver to lift the user's legs onto conventional foot pedals that flip down or swing in from the sides. Once seated, the lever can be rotated to lift the footplate off the ground for transport. The lever mechanism passes over center to keep the footplate from falling unexpectedly due to jostling from uneven terrain or movement from the user. Once the destination is reached, the lever can be rotated to lower the footplate to the ground. The user can stand without fear of forgetting to apply the brakes.

In further exemplary aspects, and with reference to FIGS. 1 and 12, the wheelchair 10 can comprise a pair of drive wheels 70 and at least one motor 72. In some aspects, the wheelchair 10 can have only one motor. In these aspects, the motor can operatively couple to one drive wheel or both drive wheels. In other aspects, the wheelchair can comprise a respective motor coupled to each wheel. At least one handle 80 can be coupled to the frame 12. The at least one handle 80 can be configured for pushing by a caregiver positioned behind the wheelchair. The wheelchair 10 can comprise at least one sensor 74 configured to measure a force applied to the at least one handle. A controller 1001 can be in communication with the at least one sensor 74 and each motor 72 of the at least one motor.

The controller can be configured to receive at least one input from the at least one sensor 74 corresponding to the force applied to the at least one handle 80. The controller can further be configured to control operation of the at least one motor 72 based on at least one input from the at least one sensor 74.

In some aspects, the controller 1001 can operate the motor(s) 72 as a function of a magnitude of the force sensed by the sensor(s) 74. For example, a light force applied to the handle(s) 80 can correspond to a small amount of torque that the motor(s) provide to the drive wheel(s), and a heavy force applied to the handle can correspond to a greater amount of torque that the motor(s) provide to the drive wheel(s).

In some aspects, the wheelchair 10 can perform signal processing in order to provide smoother control when traversing rough terrain. In some aspects, the controller 1001 can control operation of the motor(s) 72 based on a plurality of inputs from the sensor(s) 74. In this way, when traversing rough terrain, impulses associated with short, momentarily high or low forces can be combined to smooth the assistance provided by the motor. In these aspects, the controller can comprise processing circuitry operative to control operation of the at least one motor as a function of the plurality of inputs. For example, the processing circuitry can be configured to integrate the plurality of inputs from the sensor. In some aspects, the processing circuitry operative to control operation of the at least one motor as a function of the plurality of inputs can comprise a moving average of the plurality of inputs. Optionally, the moving average can be a weighted average. For example, more recent inputs can be more highly weighted to permit more responsive operation of the wheelchair. In other aspects, a signal from the at least one sensor 74 can be processed before being provided to the controller. For example, the signal from the sensor(s) 74 can include signal processing to reduce noise from the sensor or to smooth out higher frequency signal from the sensor resulting from the wheelchair traveling over a rough surface.

In some aspects, the user can push the wheelchair to cause the motors to propel the wheelchair forward. In further aspects, the user can pull on the wheelchair to cause the motors to reverse. Optionally, the each motor can operate independently based on a respective input on a respective side of the wheelchair. For example, application of force to a first side can be detected by the first sensor, and the controller can cause the motor operatively coupled to the drive wheel on the first side to operate accordingly. As another example, the controller 1001 can use the magnitude of the force sensed by the sensor(s) 74 to continuously adjust the torque that the motor(s) provide to the drive wheel(s) such that the effort required from the caregiver is the same for varying inclines of the terrain.

In some aspects, the at least one sensor 74 can include left and right sensors for sensing force application of a caregiver on each side of the wheelchair 10. For example, the wheelchair 10 can comprise a first motor 72a operatively coupled to a first wheel 70a of the pair of wheels 70 and a second motor 72b operatively coupled to a second wheel 70b of the pair of wheels. In these aspects, the wheelchair can comprise a first sensor 74a configured to measure the force applied to the at least one handle 80 on a first side 82 of the wheelchair 10 and a second sensor 74b configured to measure the force applied to the at least one handle 80 on a second side 84 of the wheelchair 10. The controller 1001 can be configured to control operation of each of the first and second motors based on at least one input from the first and second sensors. Accordingly, the motors can be operated independently. Rotation of one motor 72 faster than the other can permit turning of the wheelchair 10. In further aspects, the motors can drive the wheels in opposite directions to permit tighter turns. In alternative aspects, the drive wheels can be controlled together (not independently of each other). In these aspects, the caregiver can supply the torque required to steer the wheelchair.

In some optional aspects, the at least one handle 80 and the frame 12 can be coupled by integral formation. In some aspects, the wheelchair 10 can have only one handle 80. For example, the handle 80 can extend across the back of the wheelchair 10. In other aspects, the wheelchair 10 can have a pair of handles, one handle positioned each side of the wheelchair.

In other aspects, the controller 1001 can be operative to determine at least one terrain characteristic and control operation of the at least one motor based on the determined terrain characteristic. For example, in some aspects, the at least one terrain characteristic can comprise an incline or a decline. In further aspects, the at least one terrain characteristic can comprise a surface irregularity (e.g., bumps or rough terrain).

The wheelchair can comprise at least one terrain sensor 76. The controller is operative to determine the at least one terrain characteristic based on the at least one terrain sensor 76. For example, the terrain sensor(s) 76 can comprise one or more accelerometers and/or one or more gyroscopic sensors. In some aspects, the at least one terrain sensor 76 can sense orientation of the wheelchair (e.g., a level sensor) to thereby determine whether the wheelchair is on an incline or a decline, and what the grade of the incline or decline is. In other aspects, the at least one terrain sensor 76 can detect vibrations or frequent orientation changes corresponding to rough terrain. The at least one terrain sensor 76 can include a level sensor (e.g., an accelerometer).

In other aspects, the wheelchair 10 need not measure an incline or a decline with a terrain sensor. For example, in some optional aspects, the wheelchair 10 can be free of a terrain sensor. Optionally, in these aspects, if the wheelchair 10 is on a decline, the weight of the wheelchair can cause the wheelchair to roll away from the caregiver, thereby reducing the force that the caregiver applies, thereby causing the controller 1001 to decrease power applied by the motor(s) 72. Similarly, if the wheelchair 10 is on an incline, the weight of the wheelchair can cause the wheelchair to roll toward the caregiver, thereby increasing the force that the caregiver applies, thereby causing the controller 1001 to increase power applied by the motor(s) 72.

In some aspects, the at least one sensor 74 can comprise a pressure sensor. In other aspects, the at least one sensor can comprise a force sensor (e.g., a load cell). Optionally, the force sensor can be integrated within the frame 12 and/or the handle 80. For example, wheelchair 10 can comprise a force sensor positioned between the handle and the frame (optionally, on each side of the wheelchair) so that application of force to the handle effects a force on the force sensor between the handle and the frame.

In some aspects, the at least one sensor 74 can be integrated into the frame 12 or handle(s) 80 of the wheelchair. For example, the at least one sensor 74 can comprise a strain gauge. For example, the strain gauge can be configured to measure strain of the frame 12 and/or the at least one handle 80. This configuration can provide the advantage omitting any structure protruding from the handle or interrupting the load carrying capability of the handle. In some aspects, the at least one sensor 74 can comprise a force-sensing glove.

The motor(s) 72 can comprise any suitable motor, including inline or right-angle motors, with or without geared transmission, directly or indirectly coupled to the drive wheels. For example, the rear wheels can be driven by direct drive right angle motors attached at the wheel axle.

In some aspects, the sensor(s) 74 are not position sensors (e.g., a joystick or a potentiometer).

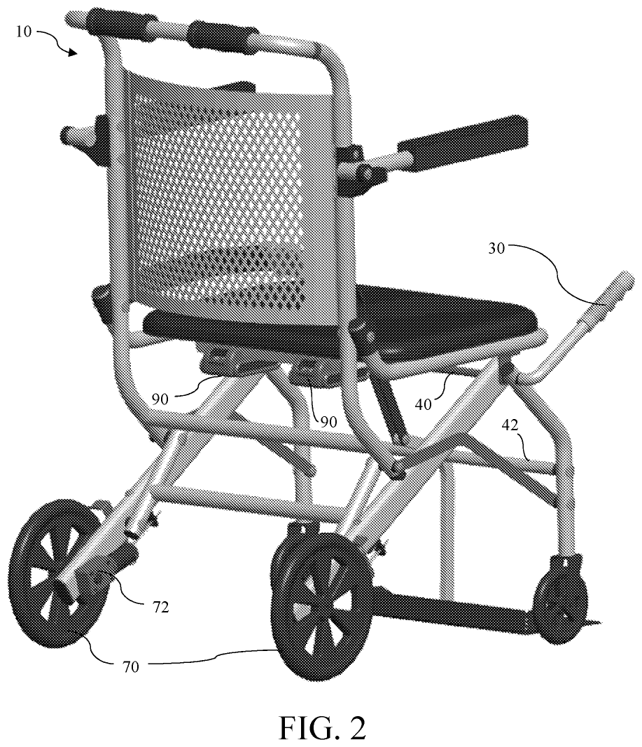

The wheelchair can further comprise at least one battery 90 (FIG. 2) operatively coupled to the motor(s) 72 and controller 1001. In some aspects, to conserve battery power, the wheelchair can comprise a mechanical brake that can be applied to disable the powertrain feature for extended stops. In some aspects, the controller 1001 and the batteries 90 can be located on the underside of the seat. The batteries 90 can easily be removed for charging, and additional batteries can be interchanged for extended travel. In some aspects, the motors 72 can serve as brakes to inhibit movement when no signal is received from the sensor(s) 74.

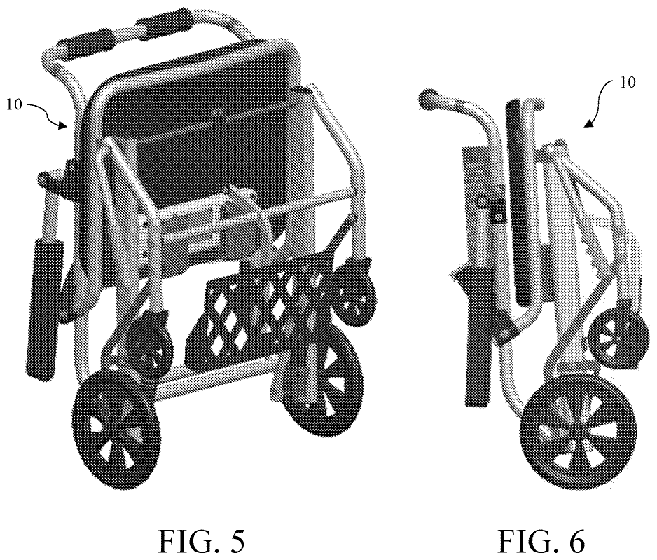

Referring to FIGS. 5-6, the wheelchair 10 can be collapsible. In some aspects, the arm rests can be pivotable to a stowed position. For example, in a use position, the arm rests can be supported by brackets. The arm rests can be pivoted upwardly and rearwardly from the brackets to extend about parallel to a back rest of the wheelchair. The wheelchair can comprise a safety latch that inhibits folding of the chair. Upon release of the safety latch, the wheelchair can be folded so that the seat folds toward the back rest. The footplate 20 can be folded upwardly toward the seat.

To move the wheelchair to a use configuration, the footplate 20 can be pivoted downwardly so that a rear flange 24 of the footplate 20 engages the arm 58 of the linkage 50.

Optionally, as shown in the profile of FIG. 6, the wheelchair 10 can have a collapsed width of less than 20 inches, or less than 18 inches, or about 17 inches. In further aspects, the wheelchair can have a collapsed height of less than 36 inches, or about 32 inches For example, the wheelchair 10 can be collapsible to within a footprint of 17 inches by 32 inches.

In various aspects, the seat of the wheelchair 10 can comprise polymer, cloth fabric wrapped around a flexible or rigid support, and with or without an integrated padded seat cushion. The frame 12 of the wheelchair 10 can comprise aluminum tubing. Constructing the wheelchair from aluminum tubing with the minimum required components for functionality allows for a weight reduction of more than 10 pounds compared to other motorized caregiver-controlled transport chairs. This design also keeps the cost low to address the concern that insurance will not cover a wheelchair designed for the caregiver rather than the care recipient. The cost of the wheelchair can be an order of magnitude lower than currently available motorized transport chairs (e.g., costing a few hundred dollars rather than thousands). The intelligent drivetrain eliminates the need to size the motorized components for the weight of the care recipient or the walking speed of the caregiver. The drop-down footplate mechanism can circumvent the requirement of lifting the care recipient's legs onto foot pedals, which can be difficult for the care recipient and often requires the caregiver to bend down and assist. Advantageously, by being provided as an engineered unit, rather than a retrofit kit for an existing wheelchair, the wheelchair can be optimized for cost, weight, size, comfort, safety, and various other factors.

The wheelchair can provide intelligent control to the caregiver. The sensor feedback provided by the handlebar to the rear wheels prevents against sudden takeoffs or decelerations common for chairs with a joystick or thumb lever control, particularly for the case when the chair is unoccupied. The wheelchair can match the pace of the caregiver and seamlessly assists with turns, ascents, descents, and uneven terrain, reducing the effort required to maneuver the care recipient through the community.

The wheelchair can have a seat width of 21 inches and weight capacity of 250 lbs. In other aspects, the wheelchair can be provided as a wider and sturdier embodiment for larger (e.g., bariatric) users. The powertrain components and assembly procedure of the wider and sturdier embodiment can be the same as the smaller version, with the structural components being interchanged for ones of longer length and higher strength.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A wheelchair comprising:
a frame;
a footplate that is coupled to the frame and movable relative to the frame about and between a lowered position and a raised position;
a lever that permits actuation of the footplate about and between the lowered position and the raised position, wherein the lever is pivotable about a first pivotal axis in a first pivotal direction from a first position in which the footplate is in the lowered position and a second position in which the footplate is in the raised position;
a first shaft coupled to the lever so that pivotal movement of the lever about the first pivotal axis effects pivotal movement of the first shaft about the first axis;
a second shaft that is pivotably coupled to the frame about a second axis, wherein the second shaft is coupled to the footplate so that pivotal movement of the second shaft effects movement of the footplate about and between the lowered position and the raised position; and
a linkage coupling the first shaft to the second shaft so that application of a downward force against the footplate when the footplate is in the raised position effects a torque applied to the first shaft in the first pivotal direction.

Aspect 2: The wheelchair of aspect 1, wherein the linkage comprises:
a first arm fixedly coupled to extending radially from the first shaft;
a second arm fixedly coupled to extending radially from the second shaft; and
a bar coupled to the first arm at a third pivotal axis and coupled to the second arm at a fourth pivotal axis,
wherein a first plane includes the first and fourth axes, wherein a second plane includes the third and fourth axes, wherein the first plane is coplanar with the second plane when the footplate is in an intermediate position between the lowered position and the raised position.

Aspect 3: The wheelchair of aspect 1 or aspect 2, wherein the linkage comprises:
a first arm fixedly coupled to extending radially from the first shaft;
a second arm fixedly coupled to extending radially from the second shaft; and
a bar coupled to the first arm at a third pivotal axis and coupled to the second arm at a fourth pivotal axis,
wherein the third pivotal axis crosses a first plane including the first and fourth axes as the footplate moves between the lowered position and the raised position.

Aspect 4: The wheelchair of any one of the preceding aspects, wherein the footplate is fixedly coupled to the second shaft so that pivotal movement of the second shaft effects corresponding pivotal movement of the footplate.

Aspect 5: The wheelchair of any one of the preceding aspects, wherein, in the lowered position, the footplate is generally parallel to the ground.

Aspect 6: The wheelchair of any one of the preceding aspects, wherein, in the lowered position, the footplate is flush with the ground.

Aspect 7: The wheelchair of any one of the preceding aspects, wherein the lever provides a mechanical advantage so that rotation of the lever by a first angle pivots the at least one pivot arm by a second angle that is less than the first angle.

Aspect 8: A wheelchair comprising:
a frame;
a pair of drive wheels rotatably coupled to the frame;
at least one motor, wherein each motor of the at least one motor coupled to at least one drive wheel of the pair of drive wheels;
at least one handle coupled to the frame, wherein the at least one handle is configured for pushing by a caregiver positioned behind the wheelchair;
at least one sensor configured to measure a force applied to the at least one handle;
and
a controller in communication with the at least one sensor and each motor of the at least one motor, wherein the controller is configured to receive at least one input from the at least one sensor corresponding to the force applied to the at least one handle, wherein the controller is configured to control operation of the at least one motor based on at least one input from the at least one sensor.

Aspect 9: The wheelchair of aspect 8, wherein the at least one input from the sensor comprises a plurality of inputs from the sensor, wherein the controller comprises processing circuitry operative to control operation of the at least one motor as a function of the plurality of inputs.

Aspect 10: The wheelchair of aspect 9, wherein the processing circuitry is configured to integrate the plurality of inputs from the sensor.

Aspect 11: The wheelchair of aspect 9 or aspect 10, wherein the processing circuitry operative to control operation of the at least one motor as a function of the plurality of inputs comprises a moving average of the plurality of inputs.

Aspect 12: The wheelchair of any one of aspects 9-11, wherein the moving average is a weighted average.

Aspect 13: The wheelchair of any one of aspects 8-12, wherein the controller is operative to:
determine at least one terrain characteristic; and
control operation of the at least one motor based on the determined terrain characteristic.

Aspect 14: The wheelchair of aspect 13, wherein the at least one terrain characteristic comprises an incline or a decline.

Aspect 15: The wheelchair of aspect 13 or aspect 14, wherein the at least one terrain characteristic comprises a surface irregularity.

Aspect 16: The wheelchair of any one of aspects 13-15, wherein the wheelchair comprises at least one terrain sensor, wherein the controller is operative to determine the at least one terrain characteristic based on the at least one terrain sensor.

Aspect 17: The wheelchair of any one of aspects 8-16, wherein the at least one motor comprises:
a first motor operatively coupled to a first wheel of the pair of wheels; and
a second motor operatively coupled to a second wheel of the pair of wheels,
   wherein the at least one sensor comprises:
a first sensor configured to measure the force applied to the at least one handle on a first side of the wheelchair; and
a second sensor configured to measure the force applied to the at least one handle on a second side of the wheelchair,
   wherein the controller is configured to control operation of each of the first and second motors based on at least one input from the first and second sensors.

Aspect 18: The wheelchair of any one of aspects 8-17, wherein the at least one sensor comprises a pressure sensor.

Aspect 19: The wheelchair of any one of aspects 8-18, wherein the at least one sensor comprises a strain gauge.

Aspect 20: The wheelchair of aspect 19, wherein the strain gauge is configured to measure strain of the frame and/or the at least one handle.

Aspect 21: The wheelchair of any one of aspects 8-20, wherein the at least one sensor is integrated into the frame.

Aspect 22: The wheelchair of any one of aspects 8-21, wherein the at least one handle and the frame are coupled by integral formation.

Aspect 23: The wheelchair of any one of aspects 8-22, wherein the at least one sensor comprises a force-sensing glove.

Aspect 24: A wheelchair comprising:
a frame;
a first structure that is pivotably coupled to the frame about a first axis, wherein the first structure comprises a lever;
a second structure that is pivotably coupled to the frame about a second axis, wherein the second structure comprises a footplate; and
a bar pivotably coupled to the first structure about a third axis and pivotably coupled to the second structure about a fourth axis,
wherein pivotal movement of the lever about the first axis effects pivotal movement of the footplate about the second axis.

Aspect 25: The wheelchair of aspect 24, wherein the footplate is movable about and between a lowered position and a raised position, at an intermediate position between the lowered position and the raised position, the wheelchair defines a toggle point at which a torque applied to the first structure by the second structure from a torque in a first direction on the second structure about the second axis changes direction.

Aspect 26: A combination of the aspects of the wheelchair as in any one of aspects 1-7 and any one of aspects 8-23.

Aspect 27: A combination of the aspects of the wheelchair as in aspect 24 or aspect 25 and any one of aspects 8-23.

Although the foregoing invention has been described in some detail by way of illustration and example for purposes of clarity of understanding, certain changes and modifications may be practiced within the scope of the appended claims.

What is claimed is:

1. A wheelchair comprising:
a frame;
a footplate that is coupled to the frame and movable relative to the frame about and between a lowered position and a raised position;
a lever that permits actuation of the footplate about and between the lowered position and the raised position, wherein the lever is pivotable about a first pivotal axis in a first pivotal direction from a first position in which the footplate is in the lowered position and a second position in which the footplate is in the raised position;
a first shaft coupled to the lever so that pivotal movement of the lever about the first pivotal axis effects pivotal movement of the first shaft about the first axis;
a second shaft that is pivotably coupled to the frame about a second axis, wherein the second shaft is coupled to the footplate so that pivotal movement of the second shaft effects movement of the footplate about and between the lowered position and the raised position; and
a linkage coupling the first shaft to the second shaft so that application of a downward force against the footplate when the footplate is in the raised position effects a torque applied to the first shaft in the first pivotal direction.

2. The wheelchair of claim 1, wherein the linkage comprises:
a first arm fixedly coupled to extending radially from the first shaft;
a second arm fixedly coupled to extending radially from the second shaft; and
a bar coupled to the first arm at a third pivotal axis and coupled to the second arm at a fourth pivotal axis,
wherein a first plane includes the first and fourth axes, wherein a second plane includes the third and fourth axes, wherein the first plane is coplanar with the second plane when the footplate is in an intermediate position between the lowered position and the raised position.

3. The wheelchair of claim 1, wherein the linkage comprises:
a first arm fixedly coupled to extending radially from the first shaft;
a second arm fixedly coupled to extending radially from the second shaft; and
a bar coupled to the first arm at a third pivotal axis and coupled to the second arm at a fourth pivotal axis,
wherein the third pivotal axis crosses a first plane including the first and fourth axes as the footplate moves between the lowered position and the raised position.

4. The wheelchair of claim 1, wherein the footplate is fixedly coupled to the second shaft so that pivotal movement of the second shaft effects corresponding pivotal movement of the footplate.

5. The wheelchair of claim 1, wherein, in the lowered position, the footplate is generally parallel to the ground.

6. The wheelchair of claim 1, wherein, in the lowered position, the footplate is flush with the ground.

7. The wheelchair of claim 1, wherein the lever provides a mechanical advantage so that rotation of the lever by a first angle pivots the at least one pivot arm by a second angle that is less than the first angle.

8. A wheelchair comprising:
a frame;
a pair of drive wheels rotatably coupled to the frame;
at least one motor, wherein each motor of the at least one motor coupled to at least one drive wheel of the pair of drive wheels;
at least one handle coupled to the frame, wherein the at least one handle is configured for pushing by a caregiver positioned behind the wheelchair;
at least one sensor configured to measure a force applied to the at least one handle;
and
a controller in communication with the at least one sensor and each motor of the at least one motor, wherein the controller is configured to receive at least one input from the at least one sensor corresponding to the force applied to the at least one handle, wherein the controller is configured to control operation of the at least one motor based on at least one input from the at least one sensor.

9. The wheelchair of claim 8, wherein the at least one input from the sensor comprises a plurality of inputs from the sensor, wherein the controller comprises processing circuitry operative to control operation of the at least one motor as a function of the plurality of inputs.

10. The wheelchair of claim 9, wherein the processing circuitry is configured to integrate the plurality of inputs from the sensor.

11. The wheelchair of claim 9, wherein the processing circuitry operative to control operation of the at least one motor as a function of the plurality of inputs comprises a moving average of the plurality of inputs.

12. The wheelchair of claim 9, wherein the moving average is a weighted average.

13. The wheelchair of claim 8, wherein the controller is operative to:
determine at least one terrain characteristic; and
control operation of the at least one motor based on the determined terrain characteristic.

14. The wheelchair of claim 13, wherein the at least one terrain characteristic comprises an incline or a decline.

15. The wheelchair of claim 13, wherein the at least one terrain characteristic comprises a surface irregularity.

16. The wheelchair of claim 13, wherein the wheelchair comprises at least one terrain sensor, wherein the controller is operative to determine the at least one terrain characteristic based on the at least one terrain sensor.

17. The wheelchair of claim 8, wherein the at least one motor comprises:
a first motor operatively coupled to a first wheel of the pair of wheels; and
a second motor operatively coupled to a second wheel of the pair of wheels, wherein the at least one sensor comprises:
a first sensor configured to measure the force applied to the at least one handle on a first side of the wheelchair; and
a second sensor configured to measure the force applied to the at least one handle on a second side of the wheelchair,
wherein the controller is configured to control operation of each of the first and second motors based on at least one input from the first and second sensors.

18. The wheelchair of claim 17, wherein the at least one sensor comprises a pressure sensor.

19. The wheelchair of claim 17, wherein the at least one sensor comprises a strain gauge.

20. The wheelchair of claim 19, wherein the strain gauge is configured to measure strain of the frame and/or the at least one handle.

21. The wheelchair of claim 8, wherein the at least one sensor is integrated into the frame.

22. The wheelchair of claim 8, wherein the at least one handle and the frame are coupled by integral formation.

23. The wheelchair of claim 8, wherein the at least one sensor comprises a force-sensing glove.

24. A wheelchair comprising:
a frame;
a first structure that is pivotably coupled to the frame about a first axis, wherein the first structure comprises a lever;
a second structure that is pivotably coupled to the frame about a second axis, wherein the second structure comprises a footplate; and
a bar pivotably coupled to the first structure about a third axis and pivotably coupled to the second structure about a fourth axis,
wherein pivotal movement of the lever about the first axis effects pivotal movement of the footplate about the second axis.

25. The wheelchair of claim 24, wherein the footplate is movable about and between a lowered position and a raised position, at an intermediate position between the lowered position and the raised position, the wheelchair defines a toggle point at which a torque applied to the first structure by the second structure from a torque in a first direction on the second structure about the second axis changes direction.
